(19) United States
(12) Patent Application Publication
(10) Pub. No.: US 2025/0124341 A1
(43) Pub. Date: Apr. 17, 2025

(54) METHOD, ELECTRONIC DEVICE, AND COMPUTER PROGRAM PRODUCT FOR CHATBOT

(71) Applicant: Dell Products L.P., Round Rock, TX (US)

(72) Inventors: Zijia Wang, Weifang (CN); Zhisong Liu, Shenzhen (CN); Wenlei Wu, Shanghai (CN); Zhen Jia, Shanghai (CN)

(21) Appl. No.: 18/505,330

(22) Filed: Nov. 9, 2023

(30) Foreign Application Priority Data
Oct. 13, 2023 (CN) 202311330928.1

(51) Int. Cl. G06N 20/00; G06F 16/332

(52) U.S. Cl. CPC G06N 20/00; G06F 16/3329

(57) ABSTRACT

Embodiments of the present disclosure relate to a method, an electronic device, and a computer program product for a chatbot. The method includes determining, based on a query entered by a user to a chatbot, a first representation associated with the query. The method further includes generating, based on the first representation and a domain to which the query belongs, a second representation, wherein dimensions of the second representation are smaller than those of the first representation. The method further includes generating, by a decoder corresponding to the domain based on the second representation, a response to the query. With embodiments of the present disclosure, quality of the generated response to the query and consistency of the response can be improved, and universality and specificity of the response can be balanced.

### RELATED APPLICATION

The present application claims priority to Chinese Patent Application No. 202311330928.1, filed Oct. 13, 2023, and entitled “Method, Electronic Device, and Computer Program Product for Chatbot,” which is incorporated by reference herein in its entirety.

### FIELD

Embodiments of the present disclosure relate to the field of computers, and more particularly, to a method, an electronic device, and a computer program product for a chatbot.

### BACKGROUND

A chatbot for a specific domain is a conversational agent that provides information or services related to the specific domain. However, most existing chatbot models are not constrained by a specific knowledge base, which can lead to irrelevant or inaccurate responses, thus being harmful to user experience and trust. Therefore, when building a chatbot for a specific domain, it is important to ensure that the chatbot can provide relevant, accurate, and reliable information and services.

### SUMMARY

Embodiments of the present disclosure provide a method, an electronic device, and a computer program product for a chatbot.

According to a first aspect of the present disclosure, a method for a chatbot is provided. The method includes determining, based on a query entered by a user to a chatbot, a first representation associated with the query. The method further includes generating, based on the first representation and a domain to which the query belongs, a second representation, wherein dimensions of the second representation are smaller than those of the first representation. The method further includes generating, by a decoder corresponding to the domain based on the second representation, a response to the query.

According to a second aspect of the present disclosure, an electronic device is provided. The electronic device includes a processor and a memory coupled to the processor, the memory having instructions stored therein, wherein the instructions, when executed by the processor, cause the electronic device to execute actions. The actions include determining, based on a query entered by a user to a chatbot, a first representation associated with the query. The actions further include generating, based on the first representation and a domain to which the query belongs, a second representation, wherein dimensions of the second representation are smaller than those of the first representation. The actions further include generating, by a decoder corresponding to the domain based on the second representation, a response to the query.

According to a third aspect of the present disclosure, a computer program product is provided. The computer program product is tangibly stored on a non-transitory computer-readable medium and includes computer-executable instructions. The computer-executable instructions, when executed by a device, cause the device to execute the method according to the first aspect.

This Summary is provided to introduce the selection of concepts in a simplified form, which will be further described in the Detailed Description below. The Summary is neither intended to identify key features or principal features of the claimed subject matter, nor intended to limit the scope of the claimed subject matter.

### BRIEF DESCRIPTION OF THE DRAWINGS

The above and other features, advantages, and aspects of embodiments of the present disclosure will become more apparent in conjunction with the accompanying drawings and with reference to the following Detailed Description. In the accompanying drawings, identical or similar reference numerals represent identical or similar elements, in which:

FIG. 1A is a schematic diagram of an example environment in which an embodiment of the present disclosure can be implemented;

FIG. 1B is a schematic diagram of an overall solution in an embodiment of the present disclosure;

FIG. 2 is a schematic diagram of an overall architecture of a method for a chatbot according to an illustrative embodiment of the present disclosure;

FIG. 3 is a flow chart of a method for a chatbot according to an illustrative embodiment of the present disclosure;

FIG. 4 is a block diagram of a workflow of a chatbot model according to an illustrative embodiment of the present disclosure;

FIG. 5 is a block diagram of a workflow of a contrasting head according to an illustrative embodiment of the present disclosure;

FIG. 6 is a block diagram of a workflow of a multi-task learning module according to an illustrative embodiment of the present disclosure; and

FIG. 7 is a block diagram of a device for a chatbot according to an illustrative embodiment of the present disclosure.

In all the accompanying drawings, identical or similar reference numerals represent identical or similar elements.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “one embodiment” or “the embodiment” should be understood as “at least one embodiment.” The terms “first,” “second,” and the like may refer to different or identical objects. Other explicit and implicit definitions may also be included below. Additionally, all specific numerical values herein are examples, which are only for aiding in understanding, and are not intended to limit the scope.

As discussed in the Background, a chatbot for a specific domain is a conversational agent that provides information or services related to the specific domain. However, most existing chatbot models are not constrained by a specific knowledge base, which can lead to irrelevant or inaccurate responses, thus being harmful to user experience and trust. To solve this problem, some conventional techniques propose to integrate domain knowledge into chatbot models using various methods, e.g., knowledge graphs, memory networks, or reinforcement learning. However, these methods either require a large amount of expensive and scarce annotated data, or rely on manually formulated rules or heuristic methods, whereas these data are not scalable or robust.

Contrastive learning is a technique of learning similar representations of positive samples and dissimilar representations of negative samples. It has been widely used for self-supervised learning, particularly in computer vision, where data augmentation is used to create pairs of positive and negative samples. However, data augmentation is often specific to a domain and requires prior knowledge about the domain. For example, image cropping and rotation may not be suitable for voice or tabular data. As a result, some conventional solutions propose domain-irrelevant methods for contrastive learning, e.g., the use of mixup noise or random projection. However, these methods do not take into account domain relevance of pairs, which may lead to suboptimal representations of tasks of a specific domain.

In order to address the above defects, an embodiment of the present disclosure provides a method for a chatbot. This solution uses contrastive learning and multi-task learning to integrate domain knowledge into the work of a chatbot model. In some embodiments, this solution uses contrastive learning to combine chatbot responses with a domain knowledge base and distinguish them from responses from other domains. In some embodiments, multi-task learning is used to learn common features and cross different tasks or domains. In some embodiments, this solution provides a lightweight contrasting head that may be easily added into any existing chatbot model, and uses a contrastive loss function to consider semantic similarity and domain relevance of a response.

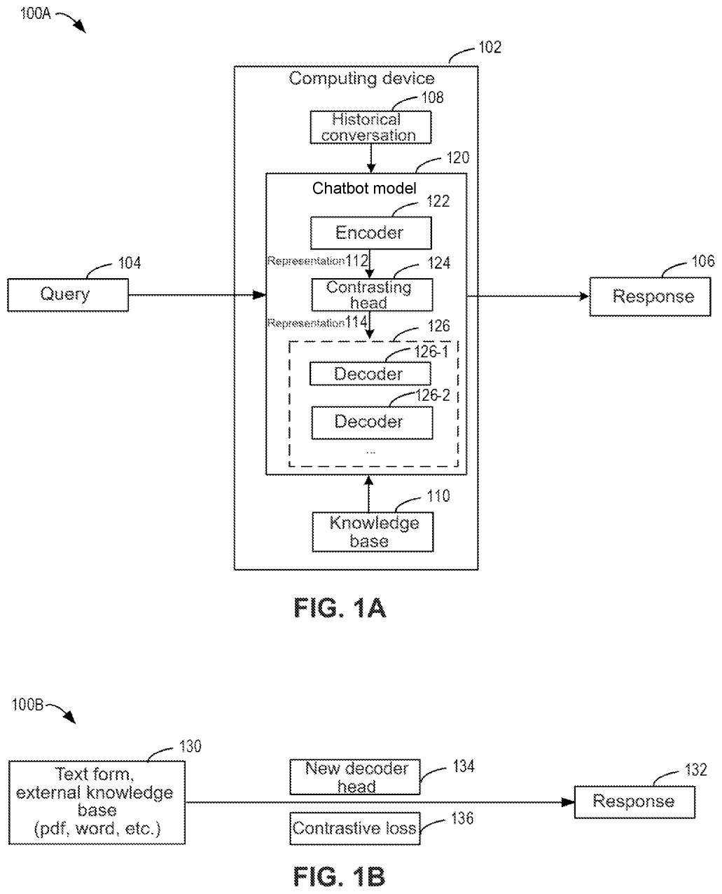

FIG. 1A is a schematic diagram of an example environment 100A in which an embodiment of the present disclosure can be implemented. As shown in FIG. 1, the example environment 100 may include a computing device 102. The computing device 102 may be, for example, a computing system or a server. A chatbot may be installed on the computing device 102, or the computing device 102 itself may be a chatbot. The computing device 102 receives an input from a user as a query 104. The input may, for example, include the user's question, e.g., in the case of a customer service chatbot, the question could be, “What is the status of my order now?” or “What are the return conditions?”

After receiving the query 104, a chatbot model 120 of the chatbot may acquire a relevant content in a historical conversation 108 of the user or a knowledge base 110. An encoder 122 in the chatbot model 120 may generate a representation 112 (also referred to as a first representation) based on one or more of the query 104, the historical conversation 108, and the knowledge base 110. The representation 112 may be input into a contrasting head 124. A representation 114 (also referred as a second representation) is generated by the contrasting head 124 in combination with a specific domain. The representation 114 contains information about a domain to which the query 104 belongs, and is thus more accurate.

The representation 114 may be input into a decoder specific to the domain to which the query 104 belongs, e.g., a decoder 126-1. In the chatbot model 120, other decoders are further included, e.g., a decoder 126-2 (the decoder 126-1, the decoder 126-2, etc. may also be collectively or individually referred to as a decoder 126). The decoder 126-1 is exclusive to the domain to which the query 104 belongs, and is thus able to perform decoding more accurately. After performing decoding on the representation 114, the decoder 126-1 generates a response 106 corresponding to the query 104. For example, if the query 104 is a question (such as: “What is the status of my order now?”), the response 106 then could be an answer (such as: “It has been sent out today”). It may be understood that the chatbot model 120 may include a plurality of decoders, each of which is specific to a different domain, and is not limited to the decoders 126-1 and 126-2 shown in FIG. 1A.

It should be understood that the description of the architecture and functions in the example environment 100A is for illustrative purposes only and does not imply any limitations to the scope of the present disclosure. Embodiments of the present disclosure may also be applied to other environments with different structures and/or functions.

FIG. 1B is a schematic diagram of an overall solution 100B in an embodiment of the present disclosure. As shown in FIG. 1B, a block 130 represents an input, and the input may be characters in the form of text. It may also be a voice convertible into characters. The input may further include an external knowledge base (e.g., word, pdf, etc.). Unlike a conventional chatbot model, this solution includes a decoder head 134 (which may also be simply referred to herein as a contrasting head), wherein the contrasting head is trained based on a specially designed contrastive loss function 136. As a result, this added lightweight contrasting head may be easily added into any existing chatbot model without extensive modifications or retraining. The use of the contrastive loss function is provided, and the contrastive loss function takes into account semantic similarity and domain relevance of a response 132, which may balance a trade-off between universality and specificity.

Before the technical solution of the present disclosure is described, it is necessary to introduce concepts related to the technical solution of the present disclosure, which is helpful for a better understanding of the technical solution of the present disclosure. One chatbot model may generate a response for a user query in a specific domain. It is supposed that the chatbot model has access to a knowledge base (KB) of a domain, which is a collection of facts or information related to the domain. For instance, a knowledge base in the retail domain may contain relevant products, prices, and comments.

The domain knowledge base may be expressed as a collection of triplets in the form of (e1, r, e2), where e1 and e2 are entities, and r is a relationship therebetween. For example, (mobile phone A, price, $999) is one triplet, indicating that a mobile phone A has a price of $999. The chatbot model may use multi-task learning to process multiple tasks or domains at the same time. The multi-task learning is a technique that uses shared representations to train a model on multiple related tasks or domains. For instance, the chatbot model may be trained in retail and banking domains, and a chatbot model that may generate a response for a user query in a specific domain may be considered. For example, the chatbot mode may be trained in the retail and banking domains, using a common encoder and a separate decoder for each domain.

A user query may be represented as q and a chatbot response as r. A hidden state of the chatbot model is represented as h, which is calculated by the encoder based on the query q. A contrastive representation of the response is represented as z, which is calculated by the contrasting head via the hidden state h. A collection representing all possible responses is R, and a collection of all possible entities is E. A collection of positive responses for a given query is represented as R⁺, and a collection of negative responses is represented as R⁻. A set of related entities for the given query is represented as E⁺, and a set of unrelated entities is represented as E⁻. A similarity function between two vectors is represented as s(·,·), and a relevance function between a vector and an entity is represented as r(·,·). A common encoder and a separate decoder may be used for each domain.

As will described in more detail below, the technical solution of the present disclosure overcomes many challenges. For example, a chatbot response not only is semantically similar to a user query, but also is related to a domain knowledge base. Specifically, significant challenges addressed by illustrative embodiments herein include how to create positive and negative pairs so as to contrastively learn from user queries and chatbot responses, how to combine contrastive representations of the chatbot responses with the domain knowledge base, how to distinguish between contrastive representations of the chatbot responses and other domain responses, how to balance the trade-off between universality and specificity of the chatbot responses, and how to design one lightweight contrasting head that may be easily added into any existing chatbot model. One or more of these challenges are overcome by the disclosed techniques, and an overall architecture of the solution of the present disclosure is thus provided.

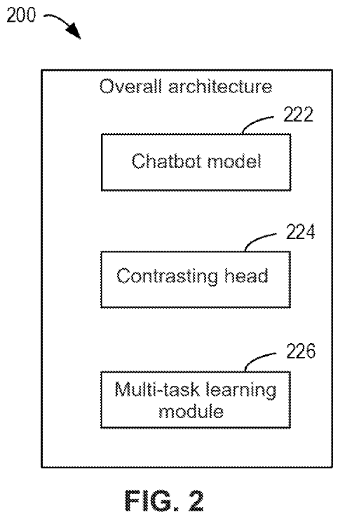

FIG. 2 is a schematic diagram of an overall architecture 200 of a method for a chatbot according to an illustrative embodiment of the present disclosure. The overall architecture 200 includes a chatbot model 222, a contrasting head 224, and a multi-task learning module 226. By implementing the overall architecture 200, it is possible to learn a contrastive representation z of each chatbot response r, wherein the contrastive representation z is similar to a hidden state h of a user query q, i.e., s(z, h) is relatively high. The contrastive representation z is related to an entity in a domain knowledge base E⁺, i.e., r(z, e) is high for all e∈E⁺. The contrastive representation z is different from a hidden state of a negative response R⁻, i.e., s(z, h′) is relatively low for all h′ corresponding to r′∈R⁻. The contrastive representation z is unrelated to an entity in other domains E⁻, i.e., r(z, e) is low for all e∈E⁻.

The chatbot model 222 generates a natural language response to a user's question. The chatbot model may be any existing pre-trained language model. The chatbot model takes as an input a user utterance, a conversation history, and a paragraph of domain knowledge retrieved from a knowledge base. The chatbot model outputs a response related to the user's question and domain knowledge.

The contrasting head 224 is one lightweight module that may be easily added into a chatbot model without extensive modifications or retraining. The contrasting head 224 learns similar representations of positive pairs and different representations of negative pairs. The positive pairs are composed of responses and domain knowledge paragraphs that are related to each other. The negative pairs are composed of responses and domain knowledge paragraphs that are not related to each other. The contrasting head 224 uses a contrastive loss function, and this function takes into account semantic similarity and domain relevance of a response. The contrasting head 224 is intended to keep chatbot responses consistent with the domain knowledge base and distinguish them from responses of other domains.

The multi-task learning module 226 is a module for training a chatbot model on multiple related tasks or domains at the same time. The multi-task learning module 226 uses a shared encoder and a task-specific decoder for each task or domain. The multi-task learning module 226 learns common features and transfers knowledge across different tasks or domains. The multi-task learning module 226 is intended to improve robustness and adaptability of the chatbot model.

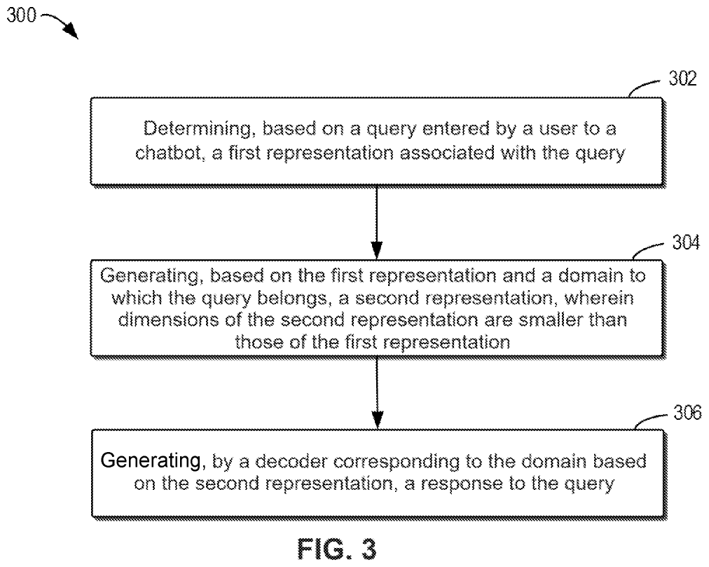

A process according to an embodiment of the present disclosure will be described in detail below with reference to FIG. 3 to FIG. 6. For the convenience of understanding, specific data mentioned in the following description is illustrative and is not intended to limit the protection scope of the present disclosure. It should be understood that embodiments described below may also include additional actions not shown and/or may omit actions shown, and the scope of the present disclosure is not limited in this regard.

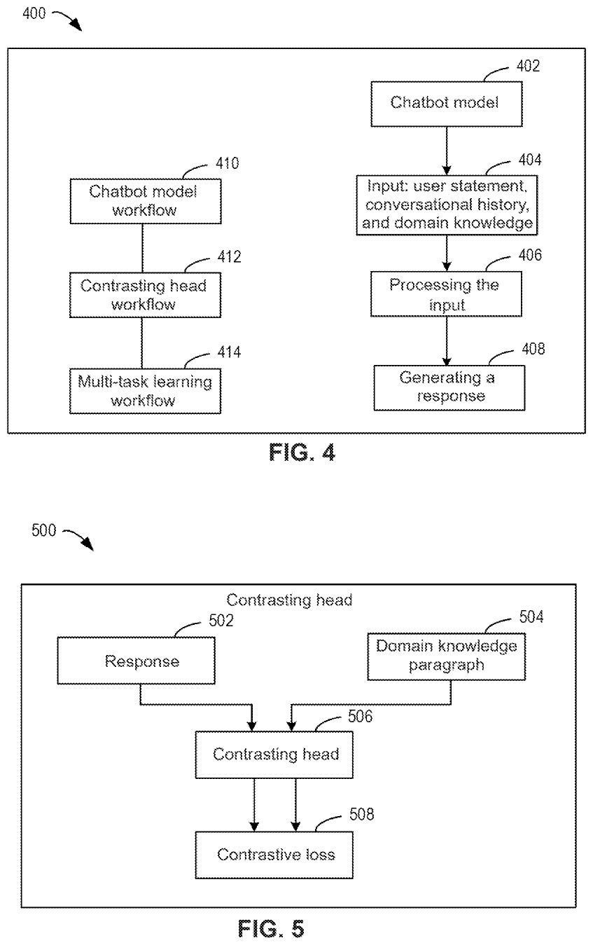

FIG. 3 is a flow chart of a method 300 for a chatbot according to an illustrative embodiment of the present disclosure. At a block 302, based on a query entered by a user to the chatbot, a first representation associated with the query is determined. For example, the chatbot model 120 receives the query 104 and determines the representation 112. Details and workflow of the chatbot model 120 will now be introduced in conjunction with FIG. 4. FIG. 4 is a block diagram of a workflow 400 of a chatbot model according to an illustrative embodiment of the present disclosure.

Generally, the workflow 400 of the chatbot model includes acquiring, by a chatbot model 402, an input 404, processing the input 406, and generating a response 408. Specifically, during processing the input 406, a chatbot model workflow 410 and a contrasting head workflow 412 may further be included. In pre-training the chatbot model, a multi-task learning workflow 414 may also be included.

As shown in FIG. 4, the chatbot model 402 generates a natural language response for a user query of a specific domain. Generally, the chatbot model 402 may be any existing or future-developed generative pre-trained language model. The chatbot model 402 takes as an input a user utterance q, a conversation history H, and a paragraph of domain knowledge K retrieved from a knowledge base. The chatbot model 402 outputs a response r related to the user query and the domain knowledge.

The chatbot model 402 includes an encoder and a decoder. The encoder is a transformer-based neural network, and it encodes the input as a hidden state sequence h=(h₁, h₂, . . . , hₙ), where n is the length of the input. The decoder is also a transformer-based neural network that generates response tokens one by one on the condition of a hidden state of the encoder and a previously generated token. The decoder uses an attention mechanism to focus on relevant parts of the encoder hidden state and the decoder hidden state. The chatbot model 402 is trained using a cross-entropy loss function, and this function measures a difference between the generated response and the real response. The cross-entropy loss function (also referred to as a first loss function) is defined as shown in Equation (1) below:

$${L}_{CE} = - \frac{1}{m} {\sum }_{i = 1}^{m} log p ( {r}_{i} \vert q , H , K ) \qquad ( 1 )$$

where m is the length of the response, and p(rᵢ|q, H, K) indicates a probability of the i-th token of the response being generated in the case of a given input.

Referring now back to FIG. 3, at a block 304, a second representation is generated based on the first representation and a domain to which the query belongs, wherein dimensions of the second representation are smaller than those of the first representation. For example, the contrasting head 124 generates the representation 114 based on the representation 112 and the domain to which the representation 112 belongs. The contrasting head will now be described in detail with reference to FIG. 5. FIG. 5 is a block diagram of a workflow 500 of a contrasting head according to an illustrative embodiment of the present disclosure.

Generally, the workflow 500 of the contrasting head includes acquiring a response 502, a domain knowledge paragraph or graph 504, a contrasting head 506, and a contrastive loss function 508. As discussed above, the contrasting head is one lightweight module that may be readily added into a chatbot model without extensive modifications or retraining. The contrasting head learns similar representations of positive pairs and different representations of negative pairs. The positive pairs are composed of responses and domain knowledge paragraphs that are related to each other. The negative pairs are composed of responses and domain knowledge paragraphs that are not related to each other. The contrasting head uses a contrastive loss function, and this function takes into account semantic similarity and domain relevance of a response. The contrasting head is aimed at keeping chatbot responses consistent with the domain knowledge base and distinguishing them from responses of other irrelevant domains.

The contrasting head takes as an input a hidden state h of the chatbot model, and outputs a contrastive representation z (i.e., a second representation) for each response r. The contrastive representation z is calculated by applying a linear transformation and subsequently normalizing the hidden state h. The linear transformation projects the hidden state h into a low-dimensional space, and the normalization ensures that the contrastive representation z has a unit length. The contrasting head may be defined as shown in Equation (2) below:

$$z = \frac{Wh + b}{‖ Wh + b ‖} \qquad ( 2 )$$

where W (also referred to as a first parameter) and b (also referred to as a second parameter) denote learnable parameters of the linear transformation. Wh+b is also referred to as a third representation.

The contrasting head is trained using a contrastive loss function, and this function measures a difference between contrastive representations of positive and negative pairs. The contrastive loss function (also referred to as a second loss function) is defined as shown in Equation (3) below:

$${L}_{CL} = - \frac{1}{N} {\sum }_{i = 1}^{N} log \frac{exp ( s ( {z}_{i} , {h}_{i}^{+} ) / τ )}{exp ( s ( {z}_{i} , {h}_{i}^{+} ) / τ ) + {\sum }_{j = 1}^{K} exp ( s ( {z}_{i} , {h}_{j}^{-} ) / τ )} \qquad ( 3 )$$

where N is the number of positive pairs, K is the number of negative pairs, τ is a temperature parameter, and s(·,·) represents a similarity function between two vectors. In some embodiments, cosine similarity is used as the similarity function, and the similarity function may be defined as shown in Equation (4) below:

$$s ( x , y ) = \frac{x \cdot y}{‖ x ‖ ‖ y ‖} \qquad ( 4 )$$

where x, y represent arbitrary vectors.

The contrastive loss function encourages a contrastive representation zᵢ to be more similar to a hidden state hᵢ⁺ of a positive response than to a hidden state hⱼ⁻ of a negative response. However, in order to prevent the contrastive loss function from only considering semantic similarity between the responses and not considering domain relevance of the responses, one add-on may be introduced into the contrastive loss function for measuring relevance between a contrastive representation z and an entity in the domain knowledge base E. The term relevance (also referred to as a third loss function) may be defined as shown in Equation (5) below:

$${L}_{RL} = - \frac{1}{N} {\sum }_{i = 1}^{N} log \frac{exp ( r ( {z}_{i} , {e}_{i}^{+} ) / τ )}{exp ( r ( {z}_{i} , {e}_{i}^{+} ) / τ ) + {\sum }_{j = 1}^{K} exp ( s ( {z}_{i} , {e}_{j}^{-} ) / τ )} \qquad ( 5 )$$

where, where r(·,·) represents a relevance function between a vector and an entity. One lookup table may be used as the relevance function, and it assigns one score to each pair of vector and entity according to a co-occurrence frequency in training data. The lookup table is initialized with random values and updated during training. The term relevance encourages the contrastive representation zᵢ to be more relevant to an entity eᵢ⁺ in the domain knowledge base than to an entity eⱼ⁻ in other domains.

A final loss function of the method 300 may be a weighted combination of cross-entropy loss, contrastive loss, and relevance loss, i.e., as shown in Equation (6) below:

$$L = {L}_{CE} + α {L}_{CL} + β {L}_{RL} \qquad ( 6 )$$

where, where α and β represent the hyper-parameters that control a trade-off between universality and specificity of a chatbot response.

The contrasting head in such a design can reduce complexity and computational overhead of the chatbot model. The contrasting head requires only the linear transformation for computing the normalization of a contrastive representation for each response, with high computing efficiency and without affecting the performance of the chatbot model. This allows the method 300 to be more flexible and compatible with different chatbot models and platforms.

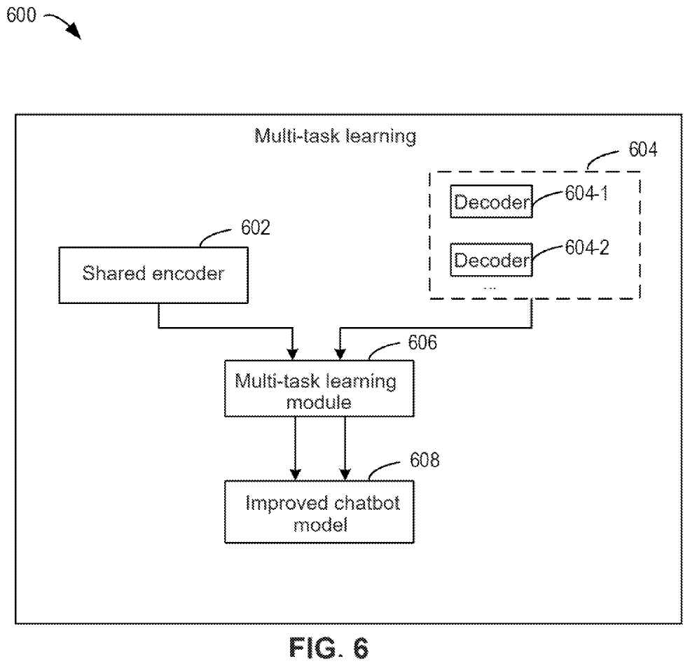

Referring now back to FIG. 3, at a block 306, a response to the query is generated by a decoder corresponding to the domain based on the second representation. For example, if the domain to which the query 104 belongs corresponds to the decoder 126-1, the decoder is then used to generate the response 106 to the query 104. In some embodiments, the decoder for a specific domain is obtained by the multi-task learning module. The multi-task learning module will now be described in detail with reference to FIG. 6.

FIG. 6 is a block diagram of a workflow 600 of a multi-task learning module according to an illustrative embodiment of the present disclosure. Generally, the workflow 600 of the multi-task learning module includes a shared encoder 602, a task-specific decoder 604-1, a task-specific decoder 604-2 (which may also be collectively referred to as multiple decoders 604), a multi-task learning module 606, and an improved chatbot model 608. The multi-task learning module is a module for training a chatbot model on multiple related tasks or domains at the same time. The multi-task learning module uses a shared encoder and a task-specific decoder for each task or domain. The multi-task learning module learns common features and transfers knowledge across different tasks or domains. The multi-task learning module is intended to improve robustness and adaptability of the chatbot model.

Specifically, the multi-task learning module takes as an input a user utterance q, a conversation history H, and a paragraph of domain knowledge K retrieved from a knowledge base of each task or domain. The multi-task learning module outputs a response r for each task or domain using the corresponding decoder. The shared encoder is the same as a shared encoder used in the chatbot model, and it encodes the input as a series of hidden states h=(h₁, h₂, . . . , hₙ). The task-specific decoders are also similar to those used in the chatbot model, but they have different parameters for each task or domain.

The multi-task learning module is trained using a weighted sum of loss functions for each task or domain. The loss function for each task or domain is the same as the loss function used in the method 300, and it is a weighted combination of cross-entropy loss, contrastive loss, and relevance loss. The weighted sum of loss functions is defined as shown in Equation (7) below:

$${L}_{MTL} = {\sum }_{i = 1}^{k} {λ}_{i} {L}_{i} \qquad ( 7 )$$

where k denotes the number of tasks or domains, λᵢ denotes a hyper-parameter that controls importance of each task or domain, and Lᵢ denotes a loss function for the i-th task or domain.

The multi-task learning module may benefit from sharing information and knowledge across different tasks or domains, particularly when data in a certain task or domain is limited or noisy. The multi-task learning module may also be adapted to a new task or domain by fine-tuning the shared encoder and adding a new decoder. The multi-task learning module uses the shared encoder and the task-specific decoder for each task, and may share information and knowledge across different tasks or domains. This may benefit from data augmentation and regularization effects, particularly when data in a certain task or domain is limited or noisy. This may further enable the chatbot model to adapt to a new task or domain by fine-tuning the shared encoder and adding a new decoder.

In this way, by implementing an embodiment as provided in the method 300, domain knowledge can be incorporated into the chatbot model through contrastive learning and multi-task learning. In some embodiments, a lightweight contrasting head can be readily added into any existing chatbot model, and a contrastive loss function takes into account semantic similarity and domain relevance of a response. In some embodiments, it is possible to process multiple tasks or domains simultaneously and to improve quality and consistency of chatbot responses in different domains. As a result, it is possible to enhance user experience and trust, increase the sales conversion rate, and reduce the cost on manual customer services.

Further, by implementing the method 300, it is possible to use domain knowledge to generate relevant and accurate responses to support and satisfy users' queries in different domains, e.g., questions about product information, technical information, etc., order status, and the like. This can lead to increased customer satisfaction and loyalty, as well as reduced churn and complaints.

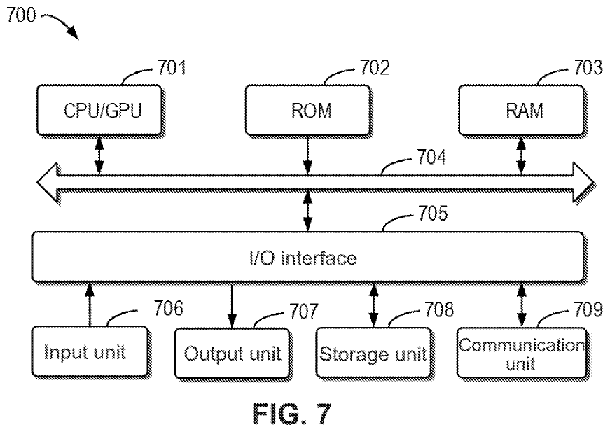

FIG. 7 shows a schematic block diagram of a device 700 that may be used to implement an embodiment of the present disclosure. The device 700 may be a device or apparatus as described in an embodiment of the present disclosure. As shown in FIG. 7, the device 700 includes a central processing unit and/or graphics processing unit (CPU/GPU) 701 that may perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The CPU/GPU 701, the ROM 702, and the RAM 703 are connected to one another through a bus 704. An input/output (I/O) interface 705 is also connected to the bus 704. Although not shown in FIG. 7, the device 700 may further include a co-processor.

A plurality of components in the device 700 are connected to the I/O interface 705, including: an input unit 706, e.g., a keyboard, a mouse, etc.; an output unit 707, e.g., various types of displays, speakers, etc.; a storage unit 708, e.g., a magnetic disk, an optical disc, etc.; and a communication unit 709, e.g., a network card, a modem, a wireless communication transceiver, etc. The communication unit 709 allows the device 700 to exchange information/data with other devices via a computer network, such as the Internet, and/or various telecommunication networks.

The various methods or processes described above may be executed by the CPU/GPU 701. For example, in some embodiments, the method may be implemented as a computer software program that is tangibly contained in a machine-readable medium, e.g., the storage unit 708. In some embodiments, part or all of the computer program may be loaded and/or installed onto the device 700 via the ROM 702 and/or the communication unit 709. When the computer program is loaded into the RAM 703 and executed by the CPU/GPU 701, one or more steps or actions of the methods or processes described above may be executed.

In some embodiments, the methods and processes described above may be implemented as a computer program product. The computer program product may include a computer-readable storage medium on which computer-readable program instructions for executing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the above. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions marked in the blocks may also occur in an order different from that marked in the accompanying drawings. For example, two successive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a special-purpose hardware-based system that executes specified functions or actions, or using a combination of special-purpose hardware and computer instructions.

Various embodiments of the present disclosure have been described above. The foregoing description is illustrative rather than exhaustive, and is not limited to the embodiments disclosed. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the various embodiments disclosed herein.

What is claimed is:

1. A method for a chatbot, comprising:
determining, based on a query entered by a user to the chatbot, a first representation associated with the query;
generating, based on the first representation and a domain to which the query belongs, a second representation, wherein dimensions of the second representation are smaller than those of the first representation; and
generating, by a decoder corresponding to the domain based on the second representation, a response to the query.

2. The method according to claim 1, wherein determining, based on the query entered by the user to the chatbot, the first representation associated with the query comprises:
determining the first representation associated with the query based on at least one of a statement entered by the user, a historical conversation between the user and the chatbot, and a knowledge base of the domain.

3. The method according to claim 2, wherein determining the first representation associated with the query based on at least one of the statement entered by the user, the historical conversation between the user and the chatbot, and the knowledge base of the domain comprises:
acquiring the at least one of the statement, the historical conversation, and the knowledge base as the query; and
generating, based on the query and using a shared encoder of the chatbot, an implicit vector as the first representation, wherein the shared encoder is capable of encoding a query belonging to any domain.

4. The method according to claim 1, wherein generating, based on the first representation and the domain to which the query belongs, the second representation comprises:
performing a linear transformation on the first representation to determine a third representation; and
normalizing the third representation to determine the second representation.

5. The method according to claim 4, wherein the chatbot comprises a contrasting head for generating the second representation, and a first parameter and a second parameter that are associated with the linear transformation are determined by pre-training.

6. The method according to claim 5, wherein the pre-training comprises:
acquiring a collection of reference queries and a set of reference responses as positive samples, a collection of reference queries and a set of reference responses as negative samples, and a collection of training queries for the pre-training;
determining a collection of training second representations corresponding to the collection of training queries; and
adjusting the first parameter and the second parameter such that the collection of training second representations is close to a collection of first distances of the positive samples, and such that the collection of training second representations is away from second distances of the negative samples.

7. The method according to claim 6, wherein the contrasting head is obtained by training based on loss functions below:
a first loss function associated with the first representation;
a second loss function associated with the first distances and the second distances; and
a third loss function associated with the collection of second representations and a collection of a plurality of entities in a knowledge base.

8. The method according to claim 7, wherein the third loss function is associated with a lookup table that maps the collection of training second representations to corresponding entities in the plurality of entities, and the lookup table assigns a score to each training second representation in the collection of training second representations and a corresponding entity based on a co-occurrence frequency in the collection of training queries, and the co-occurrence frequency indicates a probability that the training second representation correctly matches an entity in a corresponding domain.

9. The method according to claim 1, wherein the decoder corresponding to the domain comprises an encoder with specific parameters corresponding to the domain.

10. The method according to claim 9, wherein the decoder corresponding to a particular domain is obtained by training with a plurality of first loss functions, a plurality of second loss functions, and a plurality of third loss functions of a plurality of different domains as well as a plurality of weights associated with the plurality of different domains.

11. An electronic device, comprising:
a processor; and
a memory coupled to the processor, the memory having instructions stored therein, wherein the instructions, when executed by the processor, cause the electronic device to execute actions, the actions comprising:
determining, based on a query entered by a user to a chatbot, a first representation associated with the query;
generating, based on the first representation and a domain to which the query belongs, a second representation, wherein dimensions of the second representation are smaller than those of the first representation; and
generating, by a decoder corresponding to the domain based on the second representation, a response to the query.

12. The electronic device according to claim 11, wherein determining, based on the query entered by the user to the chatbot, the first representation associated with the query comprises:
determining the first representation associated with the query based on at least one of a statement entered by the user, a historical conversation between the user and the chatbot, and a knowledge base of the domain.

13. The electronic device according to claim 12, wherein determining the first representation associated with the query based on at least one of the statement entered by the user, the historical conversation between the user and the chatbot, and the knowledge base of the domain comprises:
acquiring the at least one of the statement, the historical conversation, and the knowledge base as the query; and
generating, based on the query and using a shared encoder of the chatbot, an implicit vector as the first representation, wherein the shared encoder is capable of encoding a query belonging to any domain.

14. The electronic device according to claim 11, wherein generating, based on the first representation and the domain to which the query belongs, the second representation comprises:
performing a linear transformation on the first representation to determine a third representation; and
normalizing the third representation to determine the second representation.

15. The electronic device according to claim 14, wherein the chatbot comprises a contrasting head for generating the second representation, and a first parameter and a second parameter that are associated with the linear transformation are determined by pre-training.

16. The electronic device according to claim 15, wherein the pre-training comprises:
acquiring a collection of reference queries and a set of reference responses as positive samples, a collection of reference queries and a set of reference responses as negative samples, and a collection of training queries for the pre-training;
determining a collection of training second representations corresponding to the collection of training queries; and
adjusting the first parameter and the second parameter such that the collection of training second representations is close to a collection of first distances of the positive samples, and such that the collection of training second representations is away from second distances of the negative samples.

17. The electronic device according to claim 16, wherein the contrasting head is obtained by training based on loss functions below:
a first loss function associated with the first representation;
a second loss function associated with the first distances and the second distances; and
a third loss function associated with the collection of second representations and a collection of a plurality of entities in a knowledge base.

18. The electronic device according to claim 17, wherein the third loss function is associated with a lookup table that maps the collection of training second representations to corresponding entities in the plurality of entities, and the lookup table assigns a score to each training second representation in the collection of training second representations and a corresponding entity based on a co-occurrence frequency in the collection of training queries, and the co-occurrence frequency indicates a probability that the training second representation correctly matches an entity in a corresponding domain.

19. The electronic device according to claim 11, wherein the decoder corresponding to the domain comprises an encoder with specific parameters corresponding to the domain, wherein the decoder corresponding to a particular domain is obtained by training with a plurality of first loss functions, a plurality of second loss functions, and a plurality of third loss functions of a plurality of different domains as well as a plurality of weights associated with the plurality of different domains.

20. A computer program product, the computer program product being tangibly stored in a non-transitory computer-readable medium and comprising computer-executable instructions, wherein the computer-executable instructions, when executed by a device, cause the device to perform steps comprising:
determining, based on a query entered by a user to a chatbot, a first representation associated with the query;
generating, based on the first representation and a domain to which the query belongs, a second representation, wherein dimensions of the second representation are smaller than those of the first representation; and
generating, by a decoder corresponding to the domain based on the second representation, a response to the query.
